(19) United States
(12) Patent Application Publication
(10) Pub. No.: US 2011/0120969 A1
(43) Pub. Date: May 26, 2011

(54) Process of manufacturing ceramic substrate

(75) Inventor: Wen-Hsin Lin, Taipei City (TW)

(73) Assignee: HOLY STONE ENTERPRISE CO., LTD., Taipei City (TW)

(21) Appl. No.: 12/805,186

(22) Filed: Jul. 16, 2010

(30) Foreign Application Priority Data
Nov. 20, 2009 (TW) 098139518

(51) Int. Cl. H01B 13/32

(52) U.S. Cl. 216/13

(57) ABSTRACT

The present invention relates to a manufacturing process for the ceramics substrate, more particularly attaching a dry membrane to a surface of the metallic layer of the ceramics substrate, and removing the dry membrane from the circuit portion after exposure and development process to expose the metallic layer therein. Furthermore, the conductive metallic layer coated onto the surface of the metallic layer of the circuit, and the etching resistance layer is coated onto the surface of the conductive metallic layer, and further the dry membrane is removed and the conductive metallic layer and the metallic layer are etched. The etchant is blocked by the etching resistance layer to prevent etchant from directly contacting the surface of the conductive metallic layer. Thus, the predetermined width of the circuit will not be reduced and the precision of the circuit size can be upgraded.

This application claims the priority benefit of Taiwan patent application number 098139518, filed on Nov. 20, 2009.

### BACKGROUND OF THE INVENTION

1. Field of the Invention

The present invention relates to a process of manufacturing a ceramic substrate; particularly the ceramic substrate comprises an etching resistance layer plated on the metallic layer and the conductive metallic layer of the wiring portion, thus the etching solution would not cause reduction of surface area to the width of the wire, accordingly, the precision of the wire size can be upgraded.

2. Description of the Related Art

Following fast development of technology and demand for the better quality of life, many products have been designed for meeting rigid requirements in their applicable features. The manufacturers have invested a considerable sum of budget into the research of the integrated circuit packaging process in order to provide products to perform better transmission efficiency in the miniaturized size (for applying in the products such as cellular phone, mini-notebook computer). After years of research, a ceramic-made substrate is created with advantageous characteristics such as excellent isolation effect, chemical stability, electromagnet, high hardness, and abrasion and thermal resistance, which makes ceramic substrate to obtain better performance than the conventional substrate, and that is the reason why the ceramic substrate is more popularly used nowadays.

Generally, the metallic layer and conductive layer are attached to the ceramics substrate by thermo-compression bonding process, then a dry membrane is attached onto the conductive layer for processing further exposure, developing and etching to form circuit on the metallic layer and the conductive layer as required. Due the difficulty of etching the metallic layer, the etchant may cause excessive removal of the conductive layer; the layout of the circuit has been predetermined on the dry membrane during the process of exposure and development, and excessive removal of the conductive layer may form stair case profile between the metallic layer and the conductive layer and accordingly reduce the width of the circuit. Therefore, how to solve the above described defect is the priority issue for the manufacturers in the field.

### SUMMARY OF THE INVENTION

The present invention has been accomplished under the circumstances in view. It is therefore the main object of the present invention to provide a manufacturing process of a ceramic substrate to upgrade the precision of the product size.

The other aspect of the present invention includes after plating conductive metallic layer onto the metallic layer with the circuit, an etching resistance layer is then plated thereon. The etching resistance layer is used to protect the surface of the conductive metallic layer from etching the width of the circuit on the surface of the conductive metallic layer by the etchant solution. Thus, a determined width of the circuit after etching may be maintained, and the precession of the product size can be upgraded.

### BRIEF DESCRIPTION OF THE DRAWINGS

FIG. 1 is a flowchart according to a preferred embodiment of the present invention.

FIG. 2 is a sectional view 1 during the process according to a preferred embodiment of the present invention.

FIG. 3 is a sectional view 2 during the process according to a preferred embodiment of the present invention.

FIG. 4 is a sectional view 3 during the process according to a preferred embodiment of the present invention.

FIG. 5 is a sectional view during the process according to another preferred embodiment of the present invention.

FIG. 6 is a sectional view during the process according to another preferred embodiment of the present invention.

FIG. 7 is a flowchart according to another preferred embodiment of the present invention.

### DETAILED DESCRIPTION OF THE PREFERRED EMBODIMENT

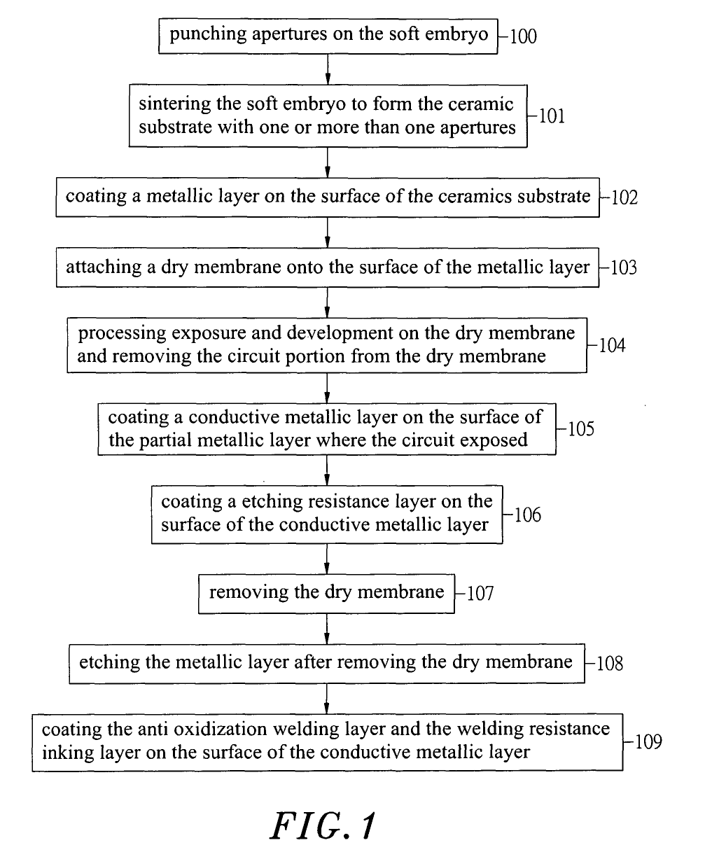

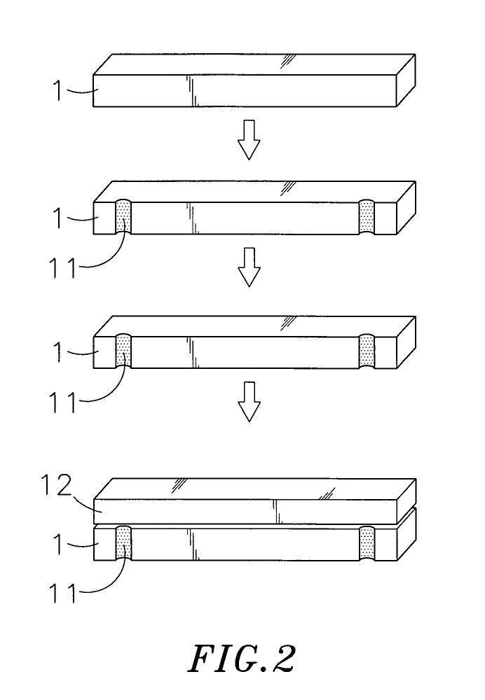

FIGS. 1, 2, 3 and 4 are a flowchart, a sectional view 1, 2 and 3 during the process according to a preferred embodiment of the present invention. Apertures on the soft embryo made of aluminum nitride (AlN) or aluminum oxide (Al₂O₃) are provided. Next, the soft embryo is sintered to form a ceramic substrate 1 with one or more than one aperture 11. Furthermore, a metallic layer 12 is coated on a surface of the ceramic substrate 1. The material of the metallic layer 12 can be selected from n alloy of nickel and chromium or nickel, chromium, silicon and copper (Ni/Cr/Si+Cu), alloy of iron and cobalt (Fe/Co), alloy of iron, cobalt and nickel (Fe/Co/Ni) or nickel, chromium or silicon. The thickness of the metallic layer 12 can be from 0.15 μm to 0.5 μm.

The metallic layer 12 has a dry membrane 2 attached on the surface for processing exposure and development in a photolithography process to remove the dry membrane 2 from the predetermined circuit, then the conductive metallic layer 13 is coated on the partial metallic layer 12 where predetermined circuit and exposed by the dry membrane 2. The material of the conductive metallic layer 13 may be copper, and the thickness of the conductive metallic layer 13 may be from 50 μm to 75 μm. An etching resistance layer 3 may be coated onto the conductive metallic layer 13, and the etching resistance layer 3 may be made of silver or gold or any other material with better etching resistance. The preferred material of forming the etching resistance layer 3 is gold, and the thickness of the etching resistance layer 3 is 0.01 μm to 0.1 μm. Furthermore, the dry membrane 2 is removed from the portion which is not predetermined for forming circuit, and etching of the metallic layer 12 is performed after the removal of the dry membrane 2. The circuit is formed after etching using, for example ferric chloride or copper chloride, to remove the metallic layer 12. The remaining etching resistance layer 3 can be removed from the conductive metallic layer 13 by using a removing agent, and then a coating process is performed on the anti oxidization welding layer 4 and coating on the welding resistance inking layer 5 to complete the process.

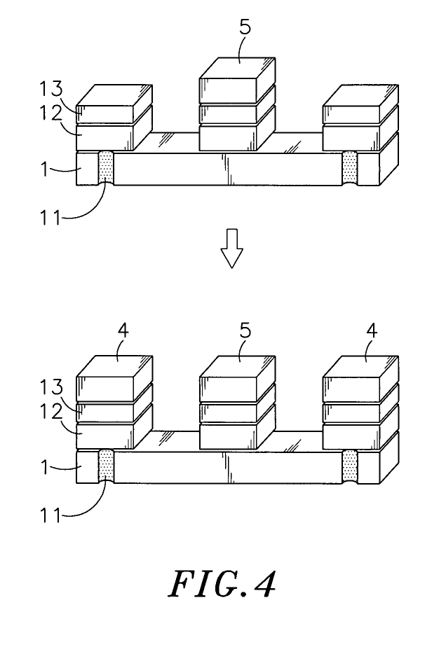

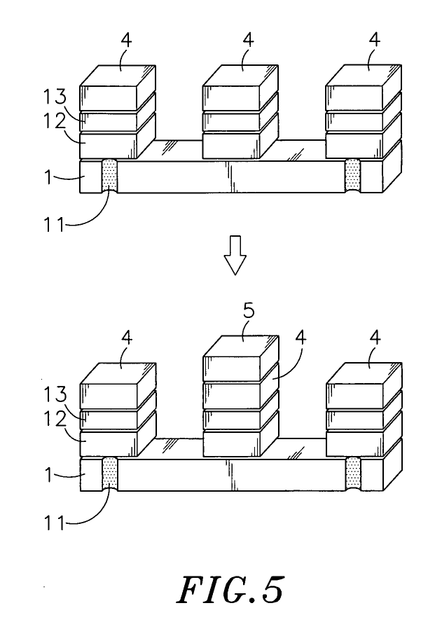

FIG. 4 and FIG. 5 are a sectional view 3 during the process according to a preferred embodiment of the present invention and a sectional view during the process according to another preferred embodiment of the present invention. The anti oxidization welding layer 4 and the welding resistance inking layer 5 are coated on the conductive metallic layer 13, the anti oxidization welding layer 4 may be coated on the predetermined position on the conductive metallic layer 13, and the anti oxidization welding layer 4 may be coated on areas the conductive metallic layer 13 where it is not coated with the welding resistance inking layer 5, thus to reduce the coating area of the anti oxidization welding layer 4 in order to reduce the manufacturing cost. Additionally, the procedure of coating the anti oxidization welding layer 4 on the conductive metallic layer 13 in advance and later coating the resistance inking layer 5 on the predetermined position can be optional, the above description is not intended for limiting the scope of the present invention, any illustrative or structural modification shall be construed to be within the scope of the present invention.

FIGS. 1, 2, 3 and 4 are a flowchart, and a sectional view 1, 2 and 3 during the process according to a preferred embodiment of the present invention. The procedure of manufacturing a ceramic substrate may include the following process steps:
(100) punching apertures on the soft embryo;
(101) sintering the soft embryo to form the ceramic substrate 1 with one or more than one apertures 11;
(102) coating a metallic layer 12 on the surface of the ceramics substrate 1;
(103) attaching a dry membrane 2 onto the surface of the metallic layer 12;
(104) processing exposure and development on the dry membrane 2 and removing the circuit portion from the dry membrane 2;
(105) coating a conductive metallic layer 13 on the surface of the partial metallic layer 12 where the circuit exposed;
(106) coating a etching resistance layer 3 on the surface of the conductive metallic layer 13;
(107) removing the dry membrane 2;
(108) etching the metallic layer 12 after removing the dry membrane 2; and
(109) coating the anti oxidization welding layer 4 and the welding resistance inking layer 5 on the surface of the conductive metallic layer 13.

The method of coating the metallic layer 12 on the surface of the ceramics substrate 1 can be sputtering the titanium or the nanometer surfactant may be used to modify the surface of the ceramics substrate 1, then further coated with nickel, chromium, gold, silver or other metal. To coat the metallic layer 12 is the common knowledge in the field and not the key point of the present invention, therefore, more detailed description thereof is omitted.

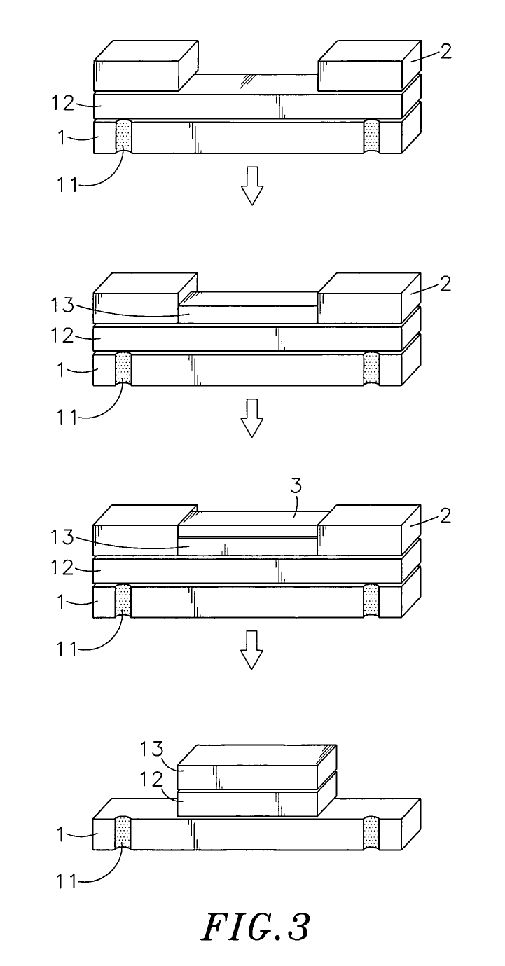

FIGS. 1 and 3 are a flowchart, and a sectional view 1 and 3 during the process according to a preferred embodiment of the present invention. By coating an etching resistance layer 3 on the conductive metallic layer 13 can prevent the etchant to directly contact the top surface of the conductive metallic layer 13, thus avoid the circuit from stair-like etching and the width of the circuit can be as the same as the predetermined size. The etchant can perform fine etching of the metallic layer 12 and the conductive metallic layer 13 of the circuit, and the circuit can be formed into a rectangular or reversed trapezoidal shape, thus not only upgrading the precision of the product but also improving the transmission effect of the circuit.

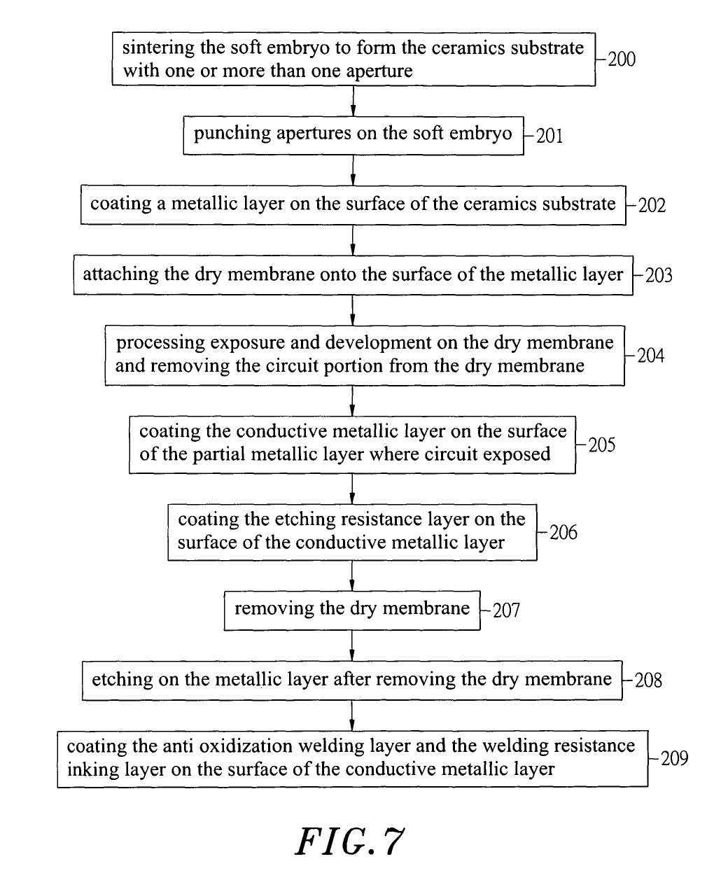

FIGS. 1, 2 and 7 are a flowchart, and a sectional view 1 and 2 during the process according to a preferred embodiment and a flowchart according to another preferred embodiment of the present invention. The process of manufacturing a ceramic substrate may be described by the following process steps:
(200) sintering the soft embryo to form the ceramics substrate 1 with one or more than one aperture 11;
(201) punching apertures on the soft embryo;
(202) coating a metallic layer 12 on the surface of the ceramics substrate 1;
(203) attaching the dry membrane 2 onto the surface of the metallic layer 12;
(204) processing exposure and development on the dry membrane 2 and removing the circuit portion from the dry membrane 2;
(205) coating the conductive metallic layer 13 on the surface of the partial metallic layer 12 where circuit exposed;
(206) coating the etching resistance layer 3 on the surface of the conductive metallic layer 13;
(207) removing the dry membrane 2;
(208) etching on the metallic layer 12 after removing the dry membrane 2; and
(209) coating the anti oxidization welding layer 4 and the welding resistance inking layer 5 on the surface of the conductive metallic layer 13.

Aluminum nitride (AlN) or aluminum oxide (Al₂O₃) may be used to form the soft embryo and one or more than one apertures 11 may be formed by using a laser after sintering, or one or more than one apertures 11 may be first formed on the soft embryo then to sintered, and the above description is not intended to limit the scope of the present invention; therefore, any illustrative or structural modification shall be construed to be within the scope of the present invention.

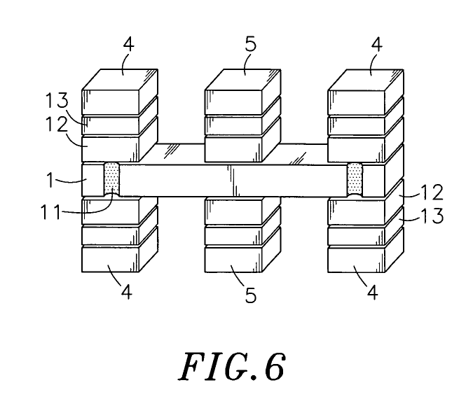

FIGS. 4 and 6 are a sectional view 3 during the process according to a preferred and a sectional view during the process according to another preferred embodiment of the present invention. The ceramic substrate may have a single side including the metallic layer 12, the conductive metallic layer 13, the anti oxidization welding layer 4 and the welding resistance inking layer 5 for forming the circuit, or include the metallic layer 12, the conductive metallic layer 13, the anti oxidization welding layer 4 and the welding resistance inking layer 5 on the both sides of the ceramics substrate 1 to form the circuit on the two sides, and the circuit on the two sides can be connected through the apertures 11 by having the conductive material coated on the inner portion of the aperture 11.

To apply the process of the ceramic substrate of the present invention, the conductive metallic layer 13 may be coated on the metallic layer 12 of the circuit, then the etching resistance layer 3 may be coated to prevent the etchant from directly contacting the surface of the conductive metallic layer 13, and the predetermined width of the circuit can be preserved and the precision of the size of the product can be upgraded.

The process of manufacturing the ceramic substrate in the present invention include orderly coating of the metallic layer 12 on the surface of the ceramics substrate 1 and attaching the dry membrane 2, and removing the dry membrane 2 after the exposure and development to form the circuit. Further, the conductive metallic layer 13, the etching resistance layer 3 may be sequentially coated onto the surface of the metallic layer 12 of the circuit, in order to prevent the reduction of the width of the circuit on the surface of the conductive metallic layer 13 while etching, and accordingly, the precision of the size of the circuit can be upgraded. Although a particular embodiment of the invention has been described in detail for purposes of illustration, various modifications and enhancements may be made without departing from the spirit and scope of the invention.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A process of manufacturing a ceramic substrate for preventing reduction of a width of a circuit formed on a surface of said ceramic substrate, said process comprising the following steps:
A. attaching a dry membrane onto a surface of a metallic layer of said ceramic substrate;
B. processing an exposure and development on the dry membrane and removing a circuit portion from the dry membrane;
C. coating a conductive metallic layer on a surface of the partial metallic layer where the circuit is exposed;
D. coating an etching resistance layer on a surface of said conductive metallic layer;
E. removing said dry membrane; and
F. etching the metallic layer after removing the dry membrane.

2. A process of manufacturing a ceramic substrate according to claim 1, wherein said ceramics substrate is made of a soft embryo having punch hole, and further sintered into said ceramics substrate with one or more than one apertures; a material of forming said soft embryo is selected from a group consisting of aluminum nitride (AlN) or aluminum oxide (Al₂O₃).

3. A process of manufacturing a ceramic substrate according to claim 1, wherein said ceramics substrate is made of a soft embryo, after sintering, to form one or more than one apertures by a laser; and a material of forming said soft embryo is selected from a group consisting of aluminum nitride (AlN) or aluminum oxide (Al₂O₃).

4. A process of manufacturing a ceramic substrate according to claim 1, wherein said ceramics substrate includes a metallic layer coated on said surface.

5. A process of manufacturing a ceramic substrate according to claim 4, wherein a material of said metallic layer is selected from a group consisting of an alloy of nickel and chromium or nickel, chromium, silicon and copper (Ni/Cr/Si+Cu), an alloy of iron and cobalt (Fe/Co), an alloy of iron, cobalt and nickel (Fe/Co/Ni) or nickel, chromium or silicon, and a thickness of the metallic layer is in a range from 0.15 μm to 0.5 μm.

6. A process of manufacturing a ceramic substrate according to claim 1, wherein a thickness of said conductive metallic layer is in a range between 50 μm to 75 μm.

7. A process of manufacturing a ceramics substrate according to claim 1, wherein said etching resistance layer comprises gold or silver, and a thickness thereof is in a range between 0.01 μm to 0.1 μm.

8. A process of manufacturing a ceramics substrate according to claim 1, wherein said etchant includes ferric chloride or copper chloride.

9. A process of manufacturing a ceramic substrate according to claim 1, wherein said metallic layer and said conductive metallic layer of said circuit on said surface of said ceramics substrate can be formed into rectangular or reversed trapezoidal shape after etching.

10. A process of manufacturing a ceramic substrate according to claim 1, wherein said after etching said metallic layer with a removal of said dry membrane, further includes a step of coating an anti oxidization welding layer and a welding resistance inking layer on said surface of said conductive metallic layer; said anti oxidization welding layer comprises gold or silver.

11. A process of manufacturing a ceramic substrate according to claim 10, wherein said welding resistance inking layer on said surface of said conductive metallic layer is disposed at a predetermined position, and coating said anti oxidization welding layer on a surface without coating with said welding resistance inking layer.

12. A process of manufacturing a ceramic substrate according to claim 11, wherein said anti oxidization welding layer is coated on a surface of said conductive metallic layer and then said welding resistance inking layer is coated on a predetermined positioned on said anti oxidization welding layer.
